(19) United States
(12) Patent Application Publication
(10) Pub. No.: US 2026/0240066 A1
(43) Pub. Date: Aug. 20, 2026

(54) ASSISTANCE SYSTEM AND METHOD FOR GENERATING VIRTUAL FIELD BOUNDARIES FOR AN AGRICULTURAL TERRITORY TO BE CULTIVATED

(71) Applicant: CLAAS Tractor SAS, Vélizy-Villacoublay Cedex (FR)

(72) Inventors: Tobias Niggemeyer, Paderborn (DE); Robin Monkenbusch, Rheda-Wiedenbrück (DE); Thiebaud Rusterholtz, Limours (FR)

(73) Assignee: CLAAS Tractor SAS, Vélizy-Villacoublay Cedex (FR)

(21) Appl. No.: 19/541,619

(22) Filed: Feb. 17, 2026

(30) Foreign Application Priority Data
Feb. 17, 2025 (DE) 10 2025 105 851.2

(51) Int. Cl. A01B 69/00; A01B 69/04; G05D 1/00

(52) U.S. Cl. CPC A01B 69/004; A01B 69/008

(57) ABSTRACT

An assistance system and a method for generating virtual field borders for an agricultural territory to be cultivated. The system is configured to provide, based on electronic data exchange for at least one autonomous agricultural work machine, a geofence data set which comprises at least field border data relating to the virtual field borders of the territory, wherein the assistance system is configured to adapt the field border data depending on the agricultural task to be performed by the at least one autonomous agricultural work machine, wherein the adaptation comprises at least the generation of safety distances to the virtual field borders to be maintained by the at least one autonomous agricultural work machine.

### CROSS REFERENCE TO RELATED APPLICATION

This application claims priority under 35 U.S.C. § 119 to German Patent Application No. DE 10 2025 105 851.2 filed Feb. 17, 2025, the entire disclosure of which is hereby incorporated by reference herein.

### TECHNICAL FIELD

The present invention relates to an assistance system for generating virtual field borders for an agricultural territory to be cultivated and to a method for generating virtual field borders for a territory to be cultivated by means of an assistance system based on electronic data exchange.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Virtual field borders are generated to ensure the safe cultivation of an agricultural territory by one or more autonomous (e.g., unmanned) agricultural work machines. The virtual field borders may specify the borders within which the at least one autonomous agricultural work machine may exclusively move during the execution of work steps.

DE 10 2022 110 128 A1, incorporated by reference herein in its entirety, discloses an assistance system of the aforementioned type. The assistance system may be configured to provide a geofence data set for one or more autonomous agricultural work machines and to monitor the use of the geofence data set by the one work machine or the plurality of autonomous agricultural work machines. The geofence data set may comprise any one, any combination, or all of: a virtual field border; field border data which determine the course of the virtual field border; or a route plan with driving routes which are transmitted by the assistance system to the at least one autonomous agricultural work machine, which may be driven by the latter within the agricultural territory bordered by the virtual field borders. Agricultural territories are not only bordered by other adjacent agricultural territories, but also by paths, roads, forests, ditches, and the like. People, animals, or vehicles, for example, may be present in these adjacent areas not used for agriculture.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates schematically and by way of example an assistance system for generating virtual field borders for a territory to be cultivated.

FIG. 2 illustrates schematically and by way of example a visualization shown by a user interface of the assistance system of safety distances to be maintained when plowing as an agricultural task to be performed.

FIG. 3 illustrates schematically and by way of example a visualization displayed by a user interface of the assistance system of safety distances to be maintained when mowing as an agricultural task to be performed.

### DETAILED DESCRIPTION

As discussed in the background, Agricultural territories are not only bordered by other adjacent agricultural territories, but also by paths, roads, forests, ditches, and the like. People, animals, or vehicles, for example, may be present in these adjacent areas not used for agriculture. The use of autonomous agricultural work machines and attachments adapted thereto may therefore be a source of hazard to people, animals, or vehicles located at the periphery of the virtual field borders.

Based on the above, an assistance system is disclosed in which the safety of the use of an autonomous agricultural work machine is improved, such as reducing or minimizing a possible hazard to the environment.

This may be achieved by an assistance system for generating virtual field borders for an agricultural territory to be cultivated. Furthermore, this may be achieved by a method for generating virtual field borders for a territory to be cultivated.

In one or some embodiments, an assistance system (which may be resident in or associated with at least one autonomous agricultural work machine) configured to generate virtual field borders for an agricultural territory to be cultivated is disclosed. The assistance system is configured to provide a geofence data set based on electronic data exchange for at least one autonomous agricultural work machine, which data set may comprise at least field border data relating to the virtual field borders of the territory. In one or some embodiments, the assistance system is configured (e.g., designed and/or programmed) to adapt the field border data depending on the agricultural task to be performed by the at least one autonomous agricultural work machine, wherein the adaptation comprises at least the generation of safety distances to the virtual field borders to be maintained by the at least one autonomous agricultural work machine (e.g., in its autonomous movement).

This may be based on the consideration that the performance of agricultural tasks by the at least one autonomous agricultural work machine may require the use of attachments designed for the given specific agricultural task in question. Due to their working and operating methods, the attachments designed for the given specific agricultural task pose different potential hazards to the environment. By generating safety distances to be maintained by the at least one autonomous agricultural work machine from the virtual field borders depending on the agricultural task to be performed by the at least one autonomous agricultural work machine, the different potential hazards to the environment may be taken into account. Further, such automatic control of the operation of the at least one autonomous agricultural work machine may thus be tailored to any one, any combination, or all of the specific environment, the specific task, or the specific attachment(s) used.

In particular, the assistance system may be configured to adjust the safety distances to be maintained by the at least one autonomous agricultural work machine to the virtual field borders, taking into account the characteristics of a spatial environment adjacent to one of the virtual field borders.

The characteristics of a spatial environment adjacent to one of the virtual field borders may comprise immediately adjacent non-agriculturally used areas, paths, roads, access roads, stands of trees, bodies of water, ditches, and the like, on which persons, animals, and/or vehicles may be present, as well as influences interfering with or preventing the performance of the agricultural task from by the at least one autonomous agricultural work machine. The characteristics of a spatial environment adjacent to one of the virtual field borders may therefore determine the potential hazard to objects in the spatial environment adjacent to one of the virtual field borders posed by the at least one autonomous agricultural work machine, as well as the influence and/or prevention of the performance of the agricultural task by the at least one autonomous agricultural work machine. A further aspect may be the avoidance of damage to the at least one autonomous agricultural work machine and/or the attachment adapted thereto by the adjustment of the field border data depending on the agricultural task to be performed by the at least one autonomous agricultural work machine.

In one or some embodiments, the assistance system may be configured to adjust at least one working parameter of the at least one autonomous agricultural work machine at the virtual field borders depending on the characteristics of the environment. An example is a plow as an attachment in which the plow is lifted when reaching an edge of the area of the territory to be cultivated in order to drive through the headland. If there is a stand of trees on a section of one of the virtual field borders, the safety distance to be maintained to the virtual field border is selected to be greater than in the case of a ditch, which allows the virtual field border to be crossed with the lifted plow as an attachment. On the other hand, in the case of an attachment designed as a sprayer, the safety distance to be maintained by the at least one autonomous agricultural work machine from the ditch, neighboring fields, or other regions adjacent to the virtual field borders is always ensured. In this regard, the safety distance may be tailored to the specific attachment used.

This may also apply when transferring an attachment from a transport position to a working position in which the working width of the attachment exceeds the width of the autonomous agricultural work machine for performing the agricultural task. Here too, the safety distance to the virtual field borders to be maintained by the at least one autonomous agricultural work machine may depend on the agricultural task to be performed by the at least one autonomous agricultural work machine or the attachment required for this purpose. Therefore, even in this configuration, it may be possible to avoid the attachment maintaining the safety distance to the virtual field borders in the transport position but exceeding one of the virtual field borders when moving into the working position.

In particular, the assistance system may be configured to adjust the driving speed as the at least one working parameter when driving along the virtual field borders. For example, the driving speed may be reduced when driving along one of the virtual field borders if a path is adjacent thereto.

In one or some embodiments, the assistance system may be configured to determine data on the characteristics of the spatial environment from reference data for the territory, which may be saved in a database and/or in a reference database independent of the database. For this purpose, the assistance system may have a processing device that communicates with the database and/or to the reference database. The processing device may communicate with the one or more autonomous agricultural work machines in order to provide the geofence data set and to monitor the one or more autonomous agricultural work machines.

In one or some embodiments, the assistance system may be configured to analyze reference data saved as image data in the database and/or the reference database by means of a machine learning system for detecting the spatial environment. The image data may, for example, be provided by a sensor system of a manned or unmanned work machine that has previously cultivated the territory. Alternatively or additionally, the image data may be or have been captured in advance by sensors remote from the work machine, for example sensors attached to a drone. Satellite images that may be retrieved from a remote independent reference database may be another source of image data.

In particular, the assistance system may be configured to adopt calibrated and/or measured field borders that are saved or may be saved in at least one data source.

In particular, the assistance system may be configured to subject the field borders adopted by the assistance system to the provision of an approval procedure before adjusting the field border data depending on the agricultural task to be performed by the at least one autonomous agricultural work machine. The field border data should therefore have closed virtual field borders that completely border an area of the agricultural territory. The release procedure may be performed manually by an operator of the assistance system by means of a user interface. By means of the user interface, the virtual field borders determined on the basis of the adopted field borders may be graphically displayed to the operator. Furthermore, the operator may confirm or correct the virtual field borders by means of the user interface.

In one or some embodiments, the assistance system may be configured to automatically approve the field borders adopted by the assistance system if the adopted field borders are based on visual recordings of a manned work machine.

In one or some embodiments, each virtual field border may be individually parameterized. In particular, in this regard, the operator of the assistance system may individually adjust the parameters of each section of the virtual field border that determine the course of the respective virtual field borders by means of user interface. To do this, the operator may specify data known to him about the characteristics of the spatial environment and/or modify the course of at least one of the virtual field borders section by section. A section-by-section modification of the courses of the virtual field borders may, for example, comprise an adjustment of angles and/or radii.

In one or some embodiments, the assistance system may be configured to vary the safety distance to be maintained by the at least one autonomous agricultural work machine depending on the presence of statically and/or dynamically operating working elements on at least one attachment adapted to the work machine. The dependence on the presence of statically and/or dynamically operating working elements may enable a more differentiated determination of the safety distance to be maintained.

As an example of an attachment having static working elements, a plow may again be cited, with the plow having no actively driven components for performing the agricultural task, (e.g., plowing) so that the impact on the environment is limited to the immediate working area. The same applies to seed drills which do not comprise any working units that affect the environment beyond their immediate working area. The immediate working area may be determined by the extension of the at least one attachment in the transverse direction and longitudinal direction. Therefore, an attachment with static working elements adapted to the at least one autonomous agricultural work machine allows an approach directly up to the virtual field borders. In this case, the possible approach may be automatically determined by the working width and position of the attachment. For example, the plow as an attachment may only protrude laterally beyond the width of the autonomous agricultural work machine on one side. A seed drill as an attachment, on the other hand, may protrude beyond the width of the autonomous agricultural work machine on both sides.

An attachment having dynamic working elements is, for example, a swather or a mower. The working elements of the swather are rotating rake rotors with tine carriers and tines attached thereto. The dynamic working elements of the mower are rotating mower discs with blades attached thereto. The rotatingly driven working elements may eject foreign objects such as stones from the immediate working area of the attachment so that they may become a hazard to living things that are located to the side of or behind the attachment. Accordingly, the safety distance to be maintained by the at least one autonomous agricultural work machine from the virtual field borders is selected to be greater than, for example, in the case of a plow, in order to counteract this hazard.

In one or some embodiments, the assistance system for monitoring the application of the geofence data set by the one or more autonomous agricultural work machines is configured based on a determined position of the one or more autonomous agricultural work machines relative to the virtual field borders to automatically control the one or more autonomous agricultural work machines in such a way to prevent one or more autonomous agricultural work machines from falling below the safety distance to the virtual field border.

In one or some embodiments, a method is disclosed for generating virtual field borders for an agricultural territory to be cultivated by means of an assistance system based on electronic data exchange, through which a geofence data set is provided for at least one autonomous agricultural work machine, which includes at least field border data relating to the virtual field borders of the territory, wherein the field border data is adjusted by the assistance system depending on the agricultural task to be performed by the at least one autonomous agricultural work machine, wherein the adjustment comprises at least the generation of safety distances to the virtual field borders to be maintained by the at least one autonomous agricultural work machine. Reference may be made to all descriptions of the assistance system according to the invention that are suitable for explaining the method as a whole.

In one or some embodiments, the adjustment of safety distances to be maintained by the at least one autonomous agricultural work machine to one of the virtual field borders may be performed taking into account the characteristics of a spatial environment adjacent to one of the virtual field borders.

In particular, in the performance of work sequences by the at least one autonomous agricultural work machine, the safety distance to be maintained may be determined depending on the agricultural task to be performed and taking into account the characteristics of the spatial environment. A work sequence to be performed may be lifting the attachment designed as a plow.

In one or some embodiments, the field border data may be adapted by the assistance system depending on the attachment adapted to the at least one autonomous agricultural work machine and designed to perform the agricultural task.

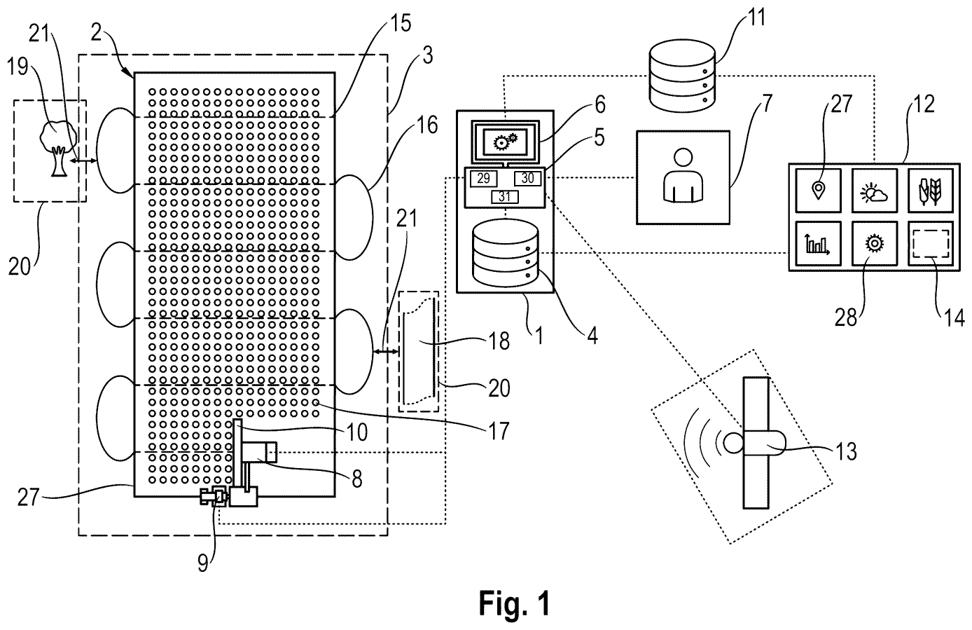

Referring to the figures, FIG. 1 illustrates schematically and by way of example an assistance system 1 for generating virtual field borders 3 for an agricultural territory 2 to be cultivated. The assistance system 1 comprises a database 4, a computing unit 5, and a user interface 6 (e.g., a touchscreen configured to output data and/or to input data). An operator 7 of the assistance system 1 may interact with the assistance system 1 via the user interface 6.

In one or some embodiments, the computing unit 5 may include at least one processor 29, at least one memory 30, and at least one communication interface 31. The at least one processor 29 and at least one memory 30 may be in communication (e.g., wired and/or wirelessly) with one another. In one or some embodiments, the processor 29 may comprise a microprocessor, controller, PLA, or the like. Similarly, the memory 30 may comprise any type of storage device (e.g., any type of memory). Though the processor 29 and the memory 30 are depicted as separate elements, they may be part of a single machine, which includes a microprocessor (or other type of controller) and a memory. Alternatively, the processor 29 may rely on the memory 30 for all of its memory needs. Still alternatively, the processor 29 may rely on a database for some or all of its memory needs. The memory 30 may comprise a tangible computer-readable medium that include software that, when executed by the processor 29 is configured to perform any one, any combination, or all of the functionality described herein, such as the automatic determination of the assistance system 1, the automatic control by the assistance system 1 of the autonomous agricultural work machines 8, 9, or the automatic operation of the autonomous agricultural work machines 8, 9. Further, the communication interface 31 may be configured to communicate (e.g., wired and/or wirelessly) with one or more electronic devices, such as external devices (e.g., servers, external databases, or the like).

The processor 29 and the memory 30 are merely one example of a computational configuration for the electronic devices discussed herein. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The user interface 6 may be configured to display various graphical representations generated by or transmitted to the computing unit 5 to the operator 7 of the assistance system 1, such as a farmer. These may include representations of one or more autonomous agricultural work machines 8, 9, one or more attachments 10 adaptable thereto, and/or the at least one agricultural territory 2 to be cultivated on which an agricultural task is to be performed with at least one work step or a sequence of work steps. Examples of autonomous agricultural work machines 8, 9 include US Patent Application Publication No. 2023/0350407 A1; US Patent Application Publication No. 2023/0350409 A1; US Patent Application Publication No. 2023/0345856 A1; US Patent Application Publication No. 2025/0147519 A1, each of which are incorporated by reference herein in their entirety.

The assistance system 1 may also be in communication with (e.g., wired and/or wirelessly via communication interface 31) a reference database 11 for the transmission of data, in which reference data 12 may be saved, which the assistance system 1 may access. The assistance system 1 has a positioning device 13 (e.g., a GPS receiver) for determining the position of the one or more autonomous agricultural work machines 8, 9 in relation to the virtual field borders 3. The positioning device 13 may be configured to determine the position by means of satellite navigation signals, wherein at least one satellite device may be used for positioning of the one or more autonomous agricultural work machines 8, 9 relative to the virtual field borders 3.

As mentioned at the outset, the territory 2 to be worked by the at least one autonomous agricultural work machine 8, 9 may be bordered by one or more of the virtual field borders 3. The assistance system 1, based on electronic data exchange, is configured to generate the virtual field borders 3 of the agricultural territory 2. The assistance system 1 may provide a geofence data set 14 for the one or more autonomous agricultural work machines 8, 9. In this regard, the assistance system 1 may provide one or both of the virtual field borders 3 of the agricultural territory 2 or the geofence data set 14. The assistance system 1 may monitor the application of the geofence data set 14 by the one or more autonomous agricultural work machines 8, 9 (e.g., the assistance system 1 may dynamically monitor the autonomous agricultural work machines 8, 9 use of the geofence data set 14). In one or some embodiments, the geofence data set 14 comprises field border data relating to the virtual field borders 3. Among other things, the field border data may determine the course and contour of the virtual field borders 3.

The assistance system 1 based on electronic data exchange is configured to generate a route plan with driving routes 15 and/or 16 for one or more autonomous agricultural work machines 8, 9 along the agricultural territory 2 bordered by the virtual field borders 3. Thus, responsive to the assistance system 1 generating the route plan with driving routes 15 and/or 16, the one or more autonomous agricultural work machines 8, 9 may autonomously or automatically operate (e.g., harvest) and/or drive according to the driving routes 15 and/or 16. For example, the at least one autonomous agricultural work machine 8 may harvest a crop 17 grown on this territory 2 as an agricultural task to be performed. The driving routes 15 and/or 16 of the route plan may take into account the virtual field borders 3 so that crossing the virtual field borders 3 by the one or more autonomous agricultural work machines 8, 9 may be prevented. These driving routes 15 and/or 16 may be sectionally straight and/or sectionally uneven, such as curved. In particular, driving routes 15 and/or 16 may form partially curved driving route sections as headlands.

Further, agricultural tasks to be performed on the territory 2 may be processes for soil cultivation, for sowing 25, for fertilizing, for mowing 24 and the like, which may be performed by the at least one autonomous agricultural work machine 8, 9 and an attachment 10 adapted thereto which may be configured according to the agricultural task to be performed.

In one or some embodiments, agricultural territories 2 may not only be bordered by other adjacent agricultural territories 26, but also by any one, any combination or all of paths 18, roads, forests 19, ditches 22, and the like, as indicated by way of example in FIG. 1. At least in these agriculturally unused regions 20 adjacent to the territory 2 to be cultivated, persons, animals, or vehicles may be present, for example. The use of autonomous agricultural work machines 8, 9 and the attachments 10 adapted thereto may be a source of danger for persons, animals, and/or vehicles located at the periphery of the virtual field borders 3.

In one or some embodiments, the assistance system 1 is configured to adapt (e.g., dynamically adapt) the field border data depending on the agricultural task to be performed by the at least one autonomous agricultural work machine 8, 9, wherein the adaptation may comprise at least the generation of safety distances 21 to the virtual field border 3 to be maintained by the at least one autonomous agricultural work machine 8, 9.

As shown for example in FIG. 1, the autonomous agricultural work machine 8 has a cutting unit as an attachment 10. The safety distance 21 to be maintained from the virtual field border 3 is determined based on the agricultural task to be performed (e.g., harvesting crop 17), so that when driving through the headland 16, the attachment 10 adapted to the autonomous agricultural work machine 8 for performing the agricultural task cannot protrude beyond the virtual field border 3 due to its working width. In this regard, the assistance system 1 may access the respective agricultural task to be performed (e.g., automatically by communicating with computing unit 5; via input from the operator using user interface 6). Responsive to the assistance system 1 accessing (such as automatically accessing) the respective agricultural task to be performed, the assistance system 1 may automatically and dynamically adapt the field border data. The field border data may therefore be adjusted depending on the agricultural task to be performed by the at least one autonomous agricultural work machine 8, 9.

Another situation in which the safety distance 21 to be maintained from the virtual field border 3 is determined based on the agricultural task to be performed arises due to the adjacent forest 19. When driving through the headland 16, the distance from the attachment 10 to neighboring trees may be too small, or vegetation at the edge of the forest 19 or the virtual field border 3 may prevent the headland 16 from being driven through without damage with the raised attachment 10. The above examples are only for illustration and are not intended to be limiting.

In one or some embodiments, the assistance system 1 is configured to automatically monitor the application of the geofence data set 14 by the one or more autonomous agricultural work machines 8, 9. In particular, the assistance system 1 may be configured to, based on a determined position of the one or more autonomous agricultural work machines 8, 9 relative to the virtual field borders 3, to automatically control the one or more autonomous agricultural work machines 8, 9 in such a way to reduce or prevent the one or more autonomous agricultural work machines 8, 9 from falling below the safety distance 21 to the virtual field border 3. In this regard, the assistance system 1 may effectively control (e.g., via commands or the like) so that the one or more autonomous agricultural work machines 8, 9 control their autonomous driving in order to prevent falling below the safety distance 21 to the virtual field border 3.

In one or some embodiments, the control for maintaining the safety distance 21 may vary (such as dynamically vary) depending on the characteristic(s) of the environment at the respective virtual field border 3. This may be the case in particular if falling below the safety distance 21 to one of the virtual field borders 3 is recognizable as not being associated with danger due to the characteristic(s) of the environment, the task to be performed, and/or the performance of the attachment 10, as explained below using the example of the agricultural task of plowing 23.

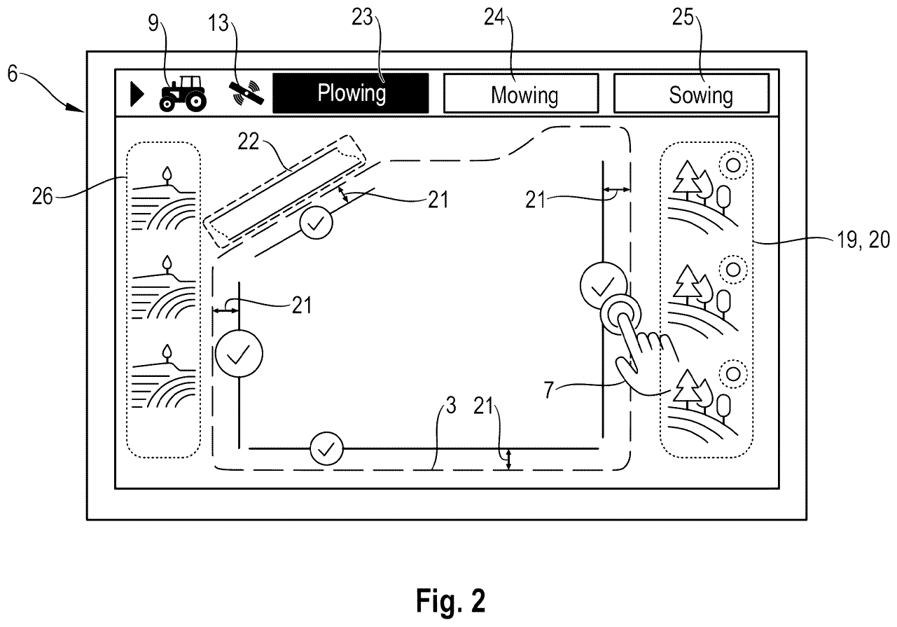

The illustration in FIG. 2 shows schematically and by way of example, a visualization displayed to the operator 7 by the user interface 6 of the assistance system 1 of the safety distances 21 to be maintained in relation to the particular virtual field border 3 when plowing 23 as the agricultural task to be performed and their release for transmission of the geofence data set 14, which may comprise the field border data and the safety distances 21 contained therein. Other agricultural tasks may include, for example, mowing 24 and sowing 25.

As previously discussed, regions 20 and/or territories 26 adjacent to the virtual field borders 3 may influence or trigger the assistance system to modify the safety distance 21 that may be maintained by the assistance system 1. The assistance system 1 may therefore be configured to adjust at least one working parameter of the at least one autonomous agricultural work machine 8, 9 depending on the characteristics of the environment at the respective virtual field borders 3 (e.g., responsive to the regions 20 and/or territories 26 adjacent to the virtual field borders 3, the assistance system 1 may automatically modify the safety distance 21; in turn, the assistance system 1 may automatically modify the at least one working parameter of the at least one autonomous agricultural work machine 8, 9 in order to automatically control the at least one autonomous agricultural work machine 8, 9 so that the at least one autonomous agricultural work machine 8, 9 operates within the modified safety distance 21).

The characteristics of a spatial environment or area 20 adjacent to the particular virtual field border 3 may comprise immediately adjacent non-agriculturally used areas, paths 18, roads, access roads, stands of trees in a forest 19, bodies of water, ditches 22, and the like, on which persons, animals, and/or vehicles may be present, as well as influences interfering with or preventing the performance of the agricultural task by the at least one autonomous agricultural work machine 8, 9. The characteristics of a spatial environment adjacent to one of the virtual field borders 3 therefore may determine the potential hazard to objects in the spatial environment adjacent to the respective virtual field border 3 from the at least one autonomous agricultural work machine 8, 9 and/or the attachment 10 adapted thereto. Similarly, the characteristics of a spatial environment adjacent to one of the virtual field borders 3 may determine the influence and/or prevention of the agricultural task being performed by the at least one autonomous agricultural work machine 8, 9. A further aspect may be the avoidance of damage to the autonomous agricultural work machine 8, 9 and/or the attachment 10 adapted thereto by the adjustment of the field border data depending on the agricultural task to be performed by the at least one autonomous agricultural work machine 8, 9.

In the case of a plow as an attachment 10, the plow is lifted (such as automatically lifted) responsive to reaching an edge of the area in the territory 2 to be cultivated in order for the at least one autonomous agricultural work machine 8, 9 to be able to drive through the headland 16. Responsive to automatically determining that the forest 19 is located on a section of one of the virtual field borders 3, the assistance system 1 may automatically determine the safety distance 21 so that the safety distance 21 to be maintained from the virtual field border 3 is automatically selected by the assistance system 1 to be greater than in the case of the ditch 22, which may allow the virtual field border 3 to be crossed with the lifted plow as an attachment 10. On the other hand, responsive to automatically determining that the attachment 10 is a sprayer, the assistance system 1 may automatically determine the safety distance 21 so that the safety distance 21 to be maintained by the at least one autonomous agricultural work machine 8, 9 from the ditch 22, neighboring fields, or other regions 20 adjacent to one of the virtual field borders 3 is ensured.

In particular, the assistance system 1 may be configured to automatically adjust the driving speed of the at least one autonomous agricultural work machine 8, 9 as the at least one working parameter when driving along the virtual field borders 3. For example, the driving speed, when driving along the virtual field borders 3, may be automatically reduced if a path 18 adjoins them. In particular, the assistance system 1 may automatically determine that the at least one autonomous agricultural work machine 8, 9 is driving (or is about to drive) along the virtual field borders 3. Responsive to this determination, the assistance system 1 may automatically modify the driving speed of the at least one autonomous agricultural work machine 8, 9 (e.g., by automatically modifying a value of the at least one working parameter).

The assistance system 1 may be configured to determine data 27 on the characteristics of the spatial environment from reference data 12 for the territory 2 to be cultivated, which may be saved in a database 4 and/or in a reference database 11 independent of the database 4. The data saved in the database 4 or reference database 11 may also be topographical information on the regions 20, which may be retrieved by the assistance system 1.

Further, data may be operating data 28 of the at least one autonomous agricultural work machine 8, 9 and the attachment 10 adapted thereto, which may be necessary for adapting the field border data depending on the agricultural task to be performed by the at least one autonomous agricultural work machine 8, 9.

In one or some embodiments, the assistance system 1 may be configured to analyze reference data 12 saved as image data in the database 4 and/or the reference database 11 by means of a machine learning system for detecting the spatial environment. The image data may, for example, be provided by a sensor system of a manned and/or unmanned work machine that has previously cultivated the territory 2. Alternatively or additionally, the image data may be or have been recorded by a sensor system remote from the work machine, for example a sensor system attached to a drone, prior to cultivation by the at least one autonomous agricultural work machine 8, 9. Satellite images that may be retrieved from a remote independent reference database 11 may be another source of image data.

The assistance system 1 may be configured to adopt calibrated and/or measured field borders that are saved or may be saved in at least one data source, such as in the database 4 and/or the reference database 11. The geofence data set 14 may comprise calibrated and/or measured and/or certified geofence data.

In particular, the assistance system 1 may be configured to subject the field borders adopted by the assistance system 1 to the provision of an approval procedure before adjusting the field border data depending on the agricultural task to be performed by the at least one autonomous agricultural work machine 8, 9. To this end, it may be incumbent upon the operator 7 to check whether the virtual field borders 3 visualized by the user interface 6 are closed.

Alternatively or additionally, the assistance system 1 may be configured to automatically approve the field borders adopted by the assistance system 1 as virtual field borders 3 if the adopted field borders are based on visual recordings of a manned machine.

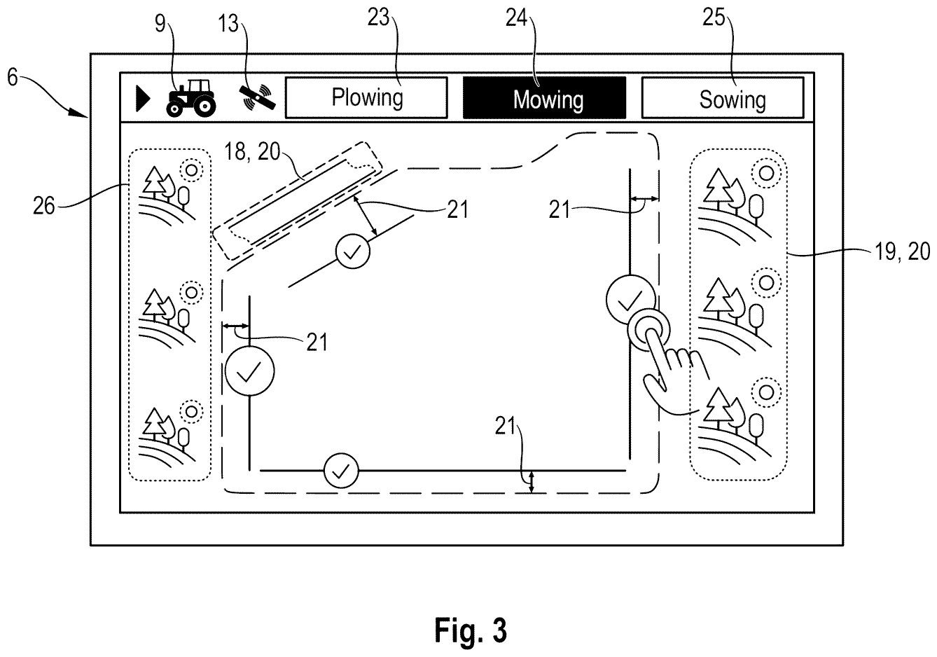

The illustration in FIG. 3 shows schematically and by way of example a visualization displayed to the operator 7 by the user interface 6 of the assistance system 1 of the safety distances 21 to be maintained in relation to the virtual field border 3 when mowing 24 as the agricultural task to be performed and their release for transmission of the geofence data set 14 which comprises the field border data and the safety distances 21 contained therein.

The at least one autonomous agricultural work machine 8 has at least one mower as an attachment 10. In this case as well, the driving speed when traveling along the virtual field borders 3 may be adjusted as at least one working parameter; in particular, the driving speed should be reduced when traveling along the virtual field borders 3 if a path 18 borders on one of the virtual field borders 3.

The assistance system 1 may be configured to automatically vary the safety distance 21 to be maintained by the at least one autonomous agricultural work machine 8, 9 depending on the presence of statically and/or dynamically operating working elements on at least one attachment 10 adapted to the work machine 8, 9. In this regard, responsive to automatically varying the safety distance 21, the assistance system 1 may automatically control operation of the at least one autonomous agricultural work machine 8, 9.

As an example of an attachment 10 having static working elements, a plow may again be cited which has no actively driven components for performing the agricultural task, that of plowing 23, so that the impact on the environment is limited to the immediate working area. The same may apply to seed drills which do not comprise any working units that affect the environment beyond their immediate working area. The immediate working area is determined by the extension of the at least one attachment 10 in the transverse direction and longitudinal direction. Therefore, an attachment 10 with static working elements adapted to the at least one autonomous agricultural work machine 8 allows an approach directly up to the virtual field borders 3. In this case, the possible approach is determined by the working width and position of the attachment 10 relative to the autonomous agricultural work machine 8, 9. For example, the plow as an attachment 10 may only protrude laterally beyond the width of the autonomous agricultural work machine 9 on one side. The cutting unit or a seed drill as an attachment 10, on the other hand, may protrude beyond the width of the autonomous agricultural work machine 8, 9 on both sides. In this regard, the assistance system 1, in dynamically and automatically controlling the autonomous agricultural work machine 8, 9 to comply with the safety distance 21, may automatically analyze the particulars of the attachment 10 (including the spatial protrusions on one or both sides), and may dynamically control operation of the autonomous agricultural work machine 8, 9 (including automatically determining which side of the attachment 10 is facing the virtual field borders 3 and adjusting the control accordingly to the spatial protrusions on one or both sides of the attachment 10).

An attachment 10 having dynamic working elements is, for example, a swather or a mower. The working elements of the swather may be rotating rake rotors with tine carriers and tines attached thereto. The dynamic working elements of the mower are rotating mower discs with blades attached thereto. The rotatingly driven working elements may eject foreign objects such as stones from the immediate working area of the attachment 10 to the rear and/or sideways so that they may become a hazard to living things that are located to the side of or behind the attachment 10. Accordingly, the safety distance 21 to be maintained by the at least one autonomous agricultural work machine 8 from the virtual field borders 3 is selected to be greater than, for example, in the case of a plow as an attachment 10 in order to counteract this hazard. In this regard, the assistance system 1 may account for this in automatically determining the safety distance 21.

In one or some embodiments, each of the virtual field borders 3 may be individually parameterized. In particular, to do this, the operator 7 of the assistance system 1 may individually adjust the parameters determining the course of each section of the virtual field borders 3 by means of the user interface 6. To do this, the operator 7 may specify data known to him about the characteristics of the spatial environment and/or modify the course of the virtual field borders 3 section by section. A section-by-section modification of the courses of the virtual field borders 3 may, for example, comprise an adjustment of angles and/or radii.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Assistance system
2 Territory
3 Virtual field boundary
4 Database
5 Computing unit
6 User interface
7 Operator
8 Autonomous agricultural work machine
9 Autonomous agricultural work machine
10 Attachment
11 Reference database
12 Reference data
13 Positioning device
14 Geofence data set
15 Driving route
16 Driving route/headland
17 Crop
18 Path
19 Forest
20 Region
21 Safety distance
22 Ditch
23 Plowing
24 Mowing
25 Sowing
26 Territory
27 Data
28 Operating data
29 Processor
30 Memory
31 Communication interface

1. At least one autonomous agricultural work machine comprising:
an assistance system configured to:
generate virtual field borders for an agricultural territory to be cultivated, which is configured to provide, based on electronic data exchange for the at least one autonomous agricultural work machine, a geofence data set which comprises at least field border data relating to the virtual field borders of the agricultural territory;
automatically adapt the at least field border data depending on an agricultural task to be performed by the at least one autonomous agricultural work machine, wherein adapting comprises at least generating safety distances to the virtual field borders to be maintained by the at least one autonomous agricultural work machine; and
automatically generate one or more commands, based on the one or more safety distances, in order to automatically control the autonomous agricultural work machine.

2. The at least one autonomous agricultural work machine of claim 1, wherein the assistance system is configured to adjust the one or more safety distances to be maintained by the at least one autonomous agricultural work machine to one of the virtual field borders, taking into account at least one characteristic of a spatial environment adjacent to the virtual field border; and
wherein the assistance system is configured to automatically generate one or more commands so that the autonomous agricultural work machine automatically moves within the agricultural territory to be no less than the one or more safety distances from the virtual field borders.

3. The at least one autonomous agricultural work machine of claim 2, wherein the assistance system is configured to automatically adjust at least one working parameter of the at least one autonomous agricultural work machine at the virtual field borders depending on the at least one characteristic of the spatial environment in order for the autonomous agricultural work machine to autonomously move within the agricultural territory to be no less than the one or more safety distances from the virtual field borders.

4. The at least one autonomous agricultural work machine of claim 3, wherein the assistance system is configured to autonomously adjust driving speed as the at least one working parameter when driving along the virtual field borders.

5. The at least one autonomous agricultural work machine of claim 4, wherein the assistance system is configured to determine data on the at least one characteristic of the spatial environment from reference data for the territory; and
wherein the data is saved in one or both of a database or a reference database independent of the database.

6. The at least one autonomous agricultural work machine of claim 5, wherein the assistance system is configured to analyze, using a machine learning system, reference data saved as image data in the one or both of the database or the reference database in order to detect the spatial environment.

7. The at least one autonomous agricultural work machine of claim 1, wherein the assistance system is configured to adopt one or both of calibrated or measured field borders that are saved or are to be saved in at least one data source.

8. The at least one autonomous agricultural work machine of claim 7, wherein the assistance system is configured to subject the field borders taken over by the assistance system to a provision of an approval procedure before adjusting the field border data depending on the agricultural task to be performed by the at least one autonomous agricultural work machine (8, 9).

9. The at least one autonomous agricultural work machine of claim 8, wherein the assistance system is configured to automatically approve the field borders adopted by the assistance system responsive to the adopted field borders being based on visual recordings of a manned machine.

10. The at least one autonomous agricultural work machine of claim 1, wherein each virtual field border of the field borders is individually parameterized.

11. The at least one autonomous agricultural work machine of claim 1, wherein the assistance system is configured to vary the safety distance to be maintained by the at least one autonomous agricultural work machine depending on one or both of presence of statically or dynamically operating working elements on at least one attachment adapted to the at least one autonomous agricultural work machine).

12. A method automatically controlling an autonomous agricultural work machine, the method comprising:
generating virtual field borders for an agricultural territory to be cultivated by an assistance system based on electronic data exchange, which provides a geofence data set for at least one autonomous agricultural work machine and which comprises at least field border data relating to the virtual field borders of the agricultural territory;
adapting, by the assistance system, the at least field border data to an agricultural task to be performed by the at least one autonomous agricultural work machine, wherein adapting comprises at least generating safety distances to the virtual field borders to be maintained by the at least one autonomous agricultural work machine; and
automatically controlling movement of the at least one autonomous agricultural work machine based on the safety distances.

13. The method of claim 12, wherein adapting the safety distances to be maintained by the at least one autonomous agricultural work machine to one of the virtual field borders is performed taking into account one or more characteristics of a respective spatial environment adjacent to a respective virtual field border.

14. The method of claim 13, wherein, in performing work sequences by the at least one autonomous agricultural work machine, at least one safety distance to be maintained is determined depending on the agricultural task to be performed and taking into account the one or more characteristics of the respective spatial environment.

15. The method of claim 14, wherein the field border data is adapted by the assistance system depending on an attachment adapted to the at least one autonomous agricultural work machine and configured to perform the agricultural task.
